(19) United States
(12) Patent Application Publication
(10) Pub. No.: US 2019/0370912 A1
(43) Pub. Date: Dec. 5, 2019

(54) Method for Creating a Recipe for a Process-Related Process Plant

(71) Applicant: Siemens Aktiengesellschaft, Muenchen (DE)

(72) Inventors: Mathias Maurmaier, Gerlingen (DE); Andreas Stutz, Eggenstein-Leopoldshafen (DE)

(21) Appl. No.: 16/424,890

(22) Filed: May 29, 2019

(30) Foreign Application Priority Data
May 30, 2018 (EP) 18175010.0

(51) Int. Cl. G06Q 50/04; G06Q 10/06

(52) U.S. Cl. CPC G06Q 50/04; G06Q 10/06312

(57) ABSTRACT

Method for creating a recipe for a process-related process plant based on at least one service, wherein the at least one service is a representation, in terms of automation technology, of concrete physical embodiments of process-related operations of the process-related process plant, where in order to create the recipe, a substitute object assigned to the service is used for each individual service, the substitute object has a parameterization, via which, when merging the created recipe and a topology of the process-related process plant, the concrete physical embodiments of the process-related operations of the process-related process plant can be incorporated into the recipe, and where the substitute object(s) is/are realized in a programmable logic controller of a control system of the process-related process plant or in a batch system of the control system of the process-related process plant.

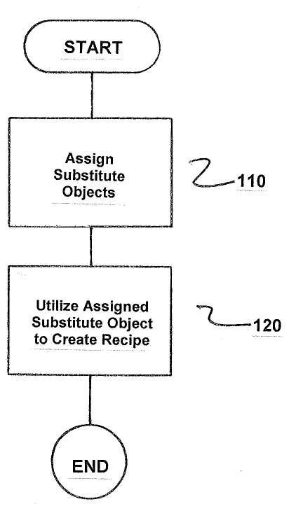

### BACKGROUND OF THE INVENTION

### 1. Field of the Invention

The invention relates to a method for creating a recipe for a process-related process plant, a programmable logic controller, a batch system of a process control system, a computer program comprising program code instructions which can be executed by a computer, and to a non-transitory computer-readable medium as claimed in claim 9.

### 2. Description of the Related Art

Modular process plants make it possible to realize a process-related production based on services. The term “service” is understood in the following to mean a representation, in terms of automation technology, of concrete physical embodiments of process-related operations of the process-related process plant. In this context, one challenge lies in realizing a process-related recipe as independently of concrete plant modules as possible, or in being able to adapt to a concrete production plant in a simple manner. A “recipe” is understood in the following to mean an operational sequence description of (optionally various) services as an orchestration description.

In order to ensure the flexibility in relation to the use of concrete service instances, and thus module instances, a recipe has to be described independently of service and module. It is regularly required that each module is designed to be per se complete and secure, here.

EP 2 866 105 A1 describes a basic technology that can be used to realize service capsules.

If the recipe contains a process-related operation, in which two modules are involved, then two services (one for each module) have to be addressed in the recipe for the fulfillment of one function. This considerably increases the outlay when creating and managing a recipe after a conversion of the process plant. One known approach for the realization of a higher-level sequential control or of a recipe for modular plants consists in adapting the step sequence with individual, highly granular services to the concrete process plant in each case. This, however, requires a high level of manual effort.

### SUMMARY OF THE INVENTION

In view of the foregoing, it is therefore an object of the invention to provide a more efficient and simplified method for creating a recipe for a process-related process plant.

This and other objects and advantages are achieved in accordance with the invention by a method for creating a recipe for a process-related process plant based on at least one service, where the at least one service is a representation, in terms of automation technology, of concrete physical embodiments of process-related operations of the process-related process plant.

The method in accordance with the invention is characterized in that, to create the recipe, a substitute object assigned to the service is used for each individual service, wherein the substitute object has a parameterization, via which, when merging the created recipe and a topology of the process-related process plant, the concrete physical embodiments of the process-related operations of the process-related process plant are able to be incorporated into the recipe.

The term “service” is understood to mean a representation, in terms of automation technology, of concrete physical embodiments of process-related operations of the process-related process plant. For example, the process-related process plant may have a service “empty”, “bring to temperature”, “stir” or “fill”.

A “recipe” is understood in the following to mean an operational sequence description of (optionally various) services as an orchestration description. The term “topology” of the process plant is understood to mean concrete structural elements, machines, sensors, actuators and the like, which are part of the process-related process plant.

The method in accordance with the invention makes it possible to uncouple the creation of a recipe for a process-related process plant from real service instances of the process-related process plant. The orchestration rule (the recipe) can therefore be generated independently of the actual implementation of the individual services of the process-related process plant. After creating the recipe, the module-independent plant recipe can then be linked via module engineering and a pool engineering, in order to obtain a module-based orchestration.

The substitute object(s) is/are realized in a programmable logic controller (PLC) of a control system of the process-related process plant or in a batch system of the control system of the process-related process plant. A “batch system” is understood to mean a part of the control system that is specifically designed for the automation of batch processes (specifically for batch-producing process plants).

In a preferred embodiment of the invention, each substitute object depicts a status of each allocated service, consisting of a process-related module to which the service is allocated, in a temporally synchronized manner, in particular in the programmable logic controller or in the batch system of a control system of the process-related process plant.

Advantageously, at least one part of the substitute objects is in each case allocated to a service with a certain service instance, which represents a certain process-related function. Accordingly, the at least one part of the substitute objects can only be used together with the one service with the certain service instance.

In a preferred embodiment of the method in accordance with the invention, a process-related module has at least one first service, which has at least one first service instance and one second service instance, which differ from one other with regard to a process-related function which is represented by it. In addition, the process-related module has at least one second service, which has at least one service instance, which represents an identical process-related function to the first or the second service instance of the first service. In this context, at least one substitute object is allocated to the service instance that the first service and the second service share identically.

In order to create the recipe for at least two different services, a substitute object allocated to the services can be used, where the services are preferably allocated to process-related modules differing from one another.

It is also an object of the invention to provide a programmable logic controller including a processor and memory, which is configured to create a recipe for a process-related process plant based on at least one service, wherein the at least one service is a representation, in terms of automation technology, of concrete physical embodiments of process-related operations of the process-related process plant.

The programmable logic controller is characterized in that, for each individual service, a substitute object assigned to the service is realized in the programmable logic controller, where the substitute object has a parameterization, via which, when merging the created recipe and a topology of the process-related process plant, the concrete physical embodiments of the process-related operations of the process-related process plant can be incorporated into the recipe.

It is also object of the invention to provide a batch system of a process control system including a processor and memory, which is configured to create a recipe for a process-related process plant based on at least one service, where the at least one service is a representation, in terms of automation technology, of concrete physical embodiments of process-related operations of the process-related process plant.

The batch system is characterized in that, for each individual service, a substitute object assigned to the service is realized in the batch system, where the substitute object has a parameterization, via which, when merging the created recipe and a topology of the process-related process plant, the concrete physical embodiments of the process-related operations of the process-related process plant can be incorporated into the recipe.

It is also an object of the invention to provide a computer program comprising program code instructions, which can be executed by a computer, for implementing the previously described method, and a computer-readable medium, comprising commands which, when executed by a computer, prompt the computer to perform the previously described method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiments of the invention will now be described with reference to the accompanying drawings, in which:

The FIGURE shows a flow chart of the method in accordance with the invention.

### DETAILED DESCRIPTION OF THE EXEMPLARY EMBODIMENTS

The FIGURE shows a flowchart of the method for creating a recipe for a process-related process plant based on at least one service, the at least one service being a representation, in terms of automation technology, of concrete physical embodiments of process-related operations of the process-related process plant. The method comprises assigning substitute objects assigned to a service for each individual service, as indicated in step 110. Next, the substitute object assigned to the service for each individual service is utilized to create the recipe, the substitute object having a parameterization, via which, when merging the created recipe and a topology of the process-related process plant, the concrete physical embodiments of the process-related operations of the process-related process plant can be incorporate into the recipe, as indicated in step 120. In accordance with the invention, substitute objects are realized in a programmable logic controller of a control system of the process-related process plant or in a batch system of the control system of the process-related process plant.

Although the invention has been illustrated and described in detail by the preferred exemplary embodiment, the invention is not restricted by the examples disclosed and other variations can be derived therefrom by a person skilled in the art without departing from the protective scope of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for creating a recipe for a process-related process plant based on at least one service, the at least one service being a representation, in terms of automation technology, of concrete physical embodiments of process-related operations of the process-related process plant, the method comprising:
assigning substitute objects assigned to a service for each individual service; and
utilizing the substitute object assigned to the service for each individual service to create the recipe, the substitute object having a parameterization, via which, when merging the created recipe and a topology of the process-related process plant, the concrete physical embodiments of the process-related operations of the process-related process plant can be incorporate into the recipe;
wherein substitute objects are realized in a programmable logic controller of a control system of the process-related process plant or in a batch system of the control system of the process-related process plant.

2. The method as claimed in claim 1, wherein the substitute objects depict a status of each allocated service, consisting of a process-related module to which the service is allocated, in a temporally synchronized manner, in the programmable logic controller or in the batch system of the control system of the process-related process plant.

3. The method as claimed in claim 1, wherein at least one part of each of the substitute objects is allocated to a service with a certain service instance, which represents a certain process-related function.

4. The method as claimed in claim 1, wherein the process-related module has at least one first service, which has at least one first service instance and one second service instance, which differ from one other with respect to a process-related function which is represented by said at least one first service;
wherein the process-related module has at least one second service, which has at least one service instance, which represents an identical process-related function to the first or the second service instance of the first service;
wherein at least one substitute object is allocated to the service instance which the first service and the second service share identically.

5. The method as claimed in claim 1, wherein a substitute object allocated to the services is utilized to create the recipe for at least two different services; and wherein the services are allocated to process-related modules differing from one another.

6. A programmable logic controller, comprising:
a processor; and
memory;
wherein the programmable logic controller is configured to:
create a recipe for a process-related process plant based on at least one service;
wherein the at least one service is a representation, in terms of automation technology, of specific physical embodiments of process-related operations of the process-related process plant;
wherein for each individual service, a substitute object assigned to the service is realized in the programmable logic controller;
wherein the substitute object has a parameterization, via which, when merging the created recipe and a topology of the process-related process plant, the specific physical embodiments of the process-related operations of the process-related process plant can be incorporated into the recipe.

7. A batch system of a process control system, comprising:
a processor; and
memory;
wherein the batch system is configured to:
create a recipe for a process-related process plant based on at least one service;
wherein the at least one service is a representation, in terms of automation technology, of specific physical embodiments of process-related operations of the process-related process plant;
wherein for each individual service, a substitute object assigned to the service is realized in the batch system;
wherein the substitute object has a parameterization, via which, when merging the created recipe and a topology of the process-related process plant, the specific physical embodiments of the process-related operations of the process-related process plant can be incorporated into the recipe.

8. A computer program comprising program code instructions, which are executable by a computer to implement the method as claimed in claim 1.

9. A non-transitory computer-readable medium, comprising commands which, when executed by a computer, prompt said computer to perform the method as claimed in claim 1.
